(19) United States
(12) Patent Application Publication
(10) Pub. No.: US 2016/0109067 A1
(43) Pub. Date: Apr. 21, 2016

(54) A METHOD OF TRANSPORTING OIL

(71) Applicant: WINTERSHALL HOLDING GMBH, Kassel (DE)

(72) Inventors: Riichiro KIMURA, Jersey City, NJ (US); Stefan MAURER, Pudong (CN); Andrei-Nicolae PARVULESCU, Ruppertsberg (DE); Lorenz SIGGEL, Heidelberg (DE); Ulrich MÜLLER, Neustadt (DE)

(21) Appl. No.: 14/892,635

(22) PCT Filed: May 20, 2014
(86) PCT No.: PCT/EP2014/060348

§ 371 Date: Nov. 20, 2015

(30) Foreign Application Priority Data
May 23, 2013 (EP) 13168884.8

(51) Int. Cl. F17D 1/17; B01D 17/04; B03C 1/01

(52) U.S. Cl. CPC F17D 1/17; B03C 1/01; B01D 17/04

(57) ABSTRACT

The presently claimed invention is related to a method of transporting oil by using a solid particles-stabilized emulsion containing water as continuous phase, oil as a dispersed phase and at least one magnetic solid particle which comprises layered double hydroxide.

The presently claimed invention is related to a method of transporting oil by using a solid particles-stabilized emulsion containing water as continuous phase, oil as a dispersed phase and at least one magnetic solid particle which comprises layered double hydroxide.

Recovery of oil from a reservoir at a point of production can result in obtaining viscous oil. The oil needs to be transported from the point of production to a point of collection, transportation or sale. However, the high viscosity of the oil detracts from its ability to be transported through pipelines and conduits. In other words, the viscosity of the oil is a limiting factor in the efficient transportation of the oil. As the viscosity of the oil increases, so do the related costs of transportation such as pumping costs.

Existing methods for increasing pipeline capacity are to heat the oil, dilute the oil with less-viscous hydrocarbon diluents, treat the oil with drag reducers, transport the oil in a core annular flow, or convert the oil into an oil-in-water (or water-external) emulsion having a viscosity lower than that of the dry oil.

WO 2003/057793 A1 discloses a method of transporting oil by forming an oil-in-water emulsion in the presence of a pH enhancing agent and hydrophilic particles such as bentonite clay and kaolinite clay both of which comprise negatively charged layers and cations in the interlayer spaces.

However, a more economic approach is to form an oil-in-water emulsion of low viscosity containing magnetic solid particles which allows for separating off the different components so that the magnetic solid particles can be reused.

Thus, an object of the presently claimed invention is to provide a process for transporting oil through a pipe or conduit that is highly economic and easy to carry out.

The object was met by providing a method of transporting oil comprising the steps of
(A) providing a solid particles-stabilized emulsion containing water as continuous phase, oil as a dispersed phase and at least one magnetic solid particle which comprises layered double hydroxide,
(B) pumping said solid particles-stabilized emulsion through a conduit or pipeline and
(C) breaking the solid particles-stabilized emulsion by application of a magnetic field to obtain oil.

An emulsion is a heterogeneous liquid system involving two immiscible phases, with one of the phases being intimately dispersed in the form of droplets in the second phase. The matrix of an emulsion is called the external or continuous phase, while the portion of the emulsion that is in the form of droplets is called the internal, dispersed or discontinuous phase.

A solid particles-stabilized emulsion according to the present invention is an emulsion that is stabilized by solid particles which adsorb onto the interface between two phases, for example an oil phase and a water phase.

The term “magnetic solid particles” refers to any type of solid particles that are magnetized upon application of an external magnetic field and are attracted by the gradient of a magnetic field, thereby becoming magnetically separable.

The term “solid” means a substance in its most highly concentrated form, i.e., the atoms or molecules comprising the substance are more closely packed with one another relative to the liquid or gaseous states of the substance.

“Oil” means a fluid containing a mixture of condensable hydrocarbons. The oil that is useful for the presently claimed invention can be any oil including but not limited to crude oil, crude oil distillates, crude oil residue, synthetic oil and mixtures thereof.

“Hydrocarbons” are organic material with molecular structures containing carbon and hydrogen.

Hydrocarbons may also include other elements, such as, but not limited to, halogens, metallic elements, nitrogen, oxygen, and/or sulfur.

Preferably the oil has a viscosity in the range of 1 to 10000 mPa·s, more preferably in the range of 10 to 5000 mPa·s, most preferably in the range of 25 to 1100 mPa·s, even more preferably in the range of 200 to 1100 mPa·s, each at a temperature of 20° C. according to DIN 53019.

Preferably, the solid-particles stabilized emulsion has a viscosity at 20° C. in the range of 1 to 30 mPa·s under shear rate of 10/s determined according to DIN 53019, more preferably in the range of 1 to 20 mPa·s under shear rate of 10/s determined according to DIN 53019.

Preferably the solid particles-stabilized emulsion comprises 10.0 to 99.0% by weight water, 10.0 to 90.0% by weight oil and 0.01 to 10.0% by weight of at least one magnetic solid particle, more preferably 50.0 to 90.0% by weight water, 10.0 to 50.0% by weight oil and 0.01 to 5.0% by weight of at least at least one magnetic solid particle, most preferably 70.0 to 90.0% by weight water, 10.0 to 30.0% by weight oil and 0.01 to 2.5% by weight of at least one magnetic solid particle, in each case related to the overall weight of the emulsion. Even more preferably the solid particles-stabilized emulsion comprises 70.0 to 90.0% by weight water, 10.0 to 30.0% by weight oil and 0.01 to 1.0% by weight of at least one magnetic solid particle, related to the overall weight of the emulsion.

Layered double hydroxides (LDH) comprise an unusual class of layered materials with positively charged layers and charge balancing anions located in the interlayer region. This is unusual in solid state chemistry: many more families of materials have negatively charged layers and cations in the interlayer spaces (e.g. kaolinite, Al₂Si₂O₅(OH)₄).

The at least one layered double hydroxide is represented by the general formula (I)

[M^{II}₍₁₋ₓ₎M^{III}ₓ(OH)₂]^{x+}[Aⁿ⁻]_{x/n}.yH₂O (I),

wherein
M^{II} denotes a divalent metal ion selected from the group consisting of Ca, Mg, Fe, Ni, Zn, Co, Cu and Mn or 2Li,
M^{III} denotes a trivalent metal ion selected from the group consisting of Al, V, Co, Sc, Ga, Y, Fe, Cr and Mn,
Aⁿ⁻ denotes an n-valent anion selected from the group consisting of OH⁻, CH₃COO⁻, PO₄³⁻, Cl⁻, Br⁻, NO₃⁻, CO₃²⁻, SO₄²⁻ and SeO₄²⁻,
x is the mole fraction having a value ranging from 0.1 to 0.5 and
y is a value ranging from 0 to 5.0.

More preferably the at least one layered double hydroxide is represented by the general formula (I)

[M^{II}₍₁₋ₓ₎M^{III}ₓ(OH)₂]^{x+}[Aⁿ⁻]_{x/n}.yH₂O (I),

wherein
M^{II} denotes Mg,
M^{III} denotes a trivalent metal ion selected from the group consisting of Fe, Co and Ni,

Aⁿ⁻ denotes an n-valent anion selected from the group consisting of Cl⁻, Br⁻, NO₃⁻, CO₃²⁻, SO₄²⁻ and SeO₄²⁻,
x is the mole fraction having a value ranging from 0.1 to 0.5 and
y is a value ranging from 0 to 5.0.

Preferably x is the mole fraction having a value ranging from 0.2 to 0.33.

Examples of the at least one layered double hydroxide include pyroaurite

[Mg₆Fe₂(CO₃)(OH)₁₆.4.5(H₂O)], sjoegrenite [Mg₆Fe₂(CO₃)(OH)₁₆.4.5(H₂O)], stichtite [Mg₆Cr₂(CO₃)(OH)₁₆.4(H₂O)], barbertonite [Mg₆Cr₂(CO₃)(OH)₁₆.4(H₂O)], takovite, reevesite [Ni₆Fe₂(CO₃)(OH)₁₆.4(H₂O)], desautelsite [Mg₆Mn₂(CO₃)(OH)₁₆CO₃.4(H₂O)], motukoreaite, wermlandite, meixnerite, coalingite, chlormagaluminite, carrboydite, honessite, woodwardite, iowaite, hydrohonessite and mountkeithite. More preferably the at least one layered double hydroxide is selected from the group consisting of pyroaurite [Mg₆Fe₂(CO₃)(OH)₁₆.4.5(H₂O)], sjoegrenite [Mg₆Fe₂(CO₃)(OH)₁₆.4.5(H₂O)], stichtite [Mg₆Cr₂(CO₃)(OH)₁₆.4(H₂O)], barbertonite

[Mg₆Cr₂(CO₃)(OH)₁₆.4(H₂O)], takovite, reevesite [Ni₆Fe₂(CO₃)(OH)₁₆.4(H₂O)] and desautelsite [Mg₆Mn₂(CO₃)(OH)₁₆CO₃.4(H₂O)]. More preferably the at least one layered double hydroxide is selected from the group consisting of pyroaurite [Mg₆Fe₂(CO₃)(OH)₁₆.4.5(H₂O)] and sjoegrenite [Mg₆Fe₂(CO₃)(OH)_{16′4.5}(H₂O)].

Preferably, the layered double hydroxide can be modified by introduction of magnetic species into the layers. The modifications allow for the preparation of layered double hydroxide with a layered structure and the composition [Me₁^{II}_{(1-Y)(1-x)}Me₂^{II}_{Y(1-X)}Me₂^{III}_{X}(OH)₂]^{X+}(Aⁿ⁻)_{X/n}, wherein X=0.2-0.33, X+Y−XY=⅔, Aⁿ⁻ is CO₃²⁻, NO₃⁻, OH⁻, SO₄²⁻; whereby Me, or/and Me₂ denote at least one metal selected from the group consisting of Fe, Ni, and Co.

In another preferred embodiment, the layered double hydroxide can be modified by introduction of magnetite (Fe₃O₄) or spinel structured MgFe₂O₄. This modification allows for increasing the magnetization.

The magnetic solid particles comprise layered double hydroxide. The actual average particle size should be sufficiently small to provide adequate surface area coverage of the internal oil phase. Preferably the solid particles have an average particle size in the range of 30 nm to 20 μm, more preferably in the range of 30 nm to 15 μm and more most preferably in the range of 40 nm to 10 μm, determined according to SEM images (as defined under Method A).

Preferably, the magnetic solid particles are paramagnetic, ferromagnetic or ferrimagnetic. Thus, preferably the magnetic solid particles show a magnetization in the range of 0.1 to 80.0 Am²/kg in a magnetic field of 1 Tesla at 300 K, more preferably in the range of 0.1 to 60.0 Am²/kg in a magnetic field of 1 Tesla at 300 K, even more preferably in the range of 0.1 to 10.0 Am²/kg in a magnetic field of 1 Tesla at 300 K and most preferably in the range of 0.1 to 5.0 Am²/kg in a magnetic field of 1 Tesla at 300 K.

As the magnetic solid particles show overall paramagnetic, ferromagnetic or ferromagnetic properties, M^{II} and/or M^{III} in formula (I) represent at least one paramagnetic ion. Thus, M^{II} and/or M^{III} in formula (I) represent at least one metal ion selected from the group consisting of Sc, V, Ni, Mn, Cr, Fe, Co and Zn.

Preferably, the aspect ratio of the magnetic solid particles which comprise layered double hydroxide is in the range of 1 to 30, more preferably in the range of 1 to 25, most preferably in the range of 1 to 23, even more preferably in the range of 2 to 22, whereby the aspect ratio is defined as diameter/thickness. The diameter and the thickness are determined according to SEM images (as defined under Method A).

Preferably, the magnetic solid particles have a BET surface area in the range of 10 to 500 m²/g, more preferably in the range of 20 to 400 m²/g, according to DIN 66315 at 77 K.

Preferably, the magnetic solid particles remain undissolved in the water phase under the inventively used conditions, but have appropriate charge distribution for stabilizing the interface between the internal droplet phase, i.e. oil, and the external continuous phase, i.e. water, to make a solid particles-stabilized oil-in-water emulsion.

Preferably, the magnetic solid particles are hydrophilic for making an oil-in-water emulsion. Thereby, the particles are properly wetted by the continuous phase, i.e. water, that holds the discontinuous phase. The appropriate hydrophilic character may be an inherent characteristic of the magnetic solid particles or either enhanced or acquired by treatment of the magnetic solid particles.

In the scope of the present invention, “hydrophilic” means that the surface of a corresponding “hydrophilic” solid particle has a contact angle with water against air of <90°. The contact angle is determined according to methods that are known to the skilled artisan, for example using a standard-instrument (Dropshape Analysis Instrument, Fa. Kruss DAS 10). A shadow image of the droplet is taken using a CCD-camera, and the shape of the droplet is acquired by computer aided image analysis. These measurements are conducted according to DIN 5560-2.

Preferably the droplets that are present in the oil-in-water emulsion have an average droplet size Dv₅₀ in the range of 1 to 100 μm, more preferably in the range of 5 to 60 μm or in the range of 1 to 60 μm and most preferably in the range of 5 to 40 μm or in the range of 1 to 10 μm, determined according to ISO13320. Dv₅₀ is defined as the volume median diameter at which 50% of the distribution is contained in droplets that are smaller than this value while the other half is contained in droplets that are larger than this value.

Preferably the droplets that are present in the oil-in-water emulsion have an average droplet size Dv₉₀ in the range of 40 to 100 μm, more preferably in the range of 40 to 80 μm and most preferably in the range of 40 to 50 μm, determined according to ISO13320. Dv₉₀ is defined as the diameter at which 90% of the distribution is contained in droplets that are smaller than this value while 10% is contained in droplets that are larger than this value.

In a preferred embodiment, the presently claimed invention relates to a method of transporting oil comprising the steps of
(A) providing a solid particles-stabilized emulsion containing water as continuous phase, oil in the form of droplets having an average droplet size Dv₅₀ in the range of 1 to 100 μm as a dispersed phase and at least one magnetic solid particle which comprises layered double hydroxide of general formula (I)

[M^{II}₍₁₋ₓ₎M^{III}ₓ(OH)₂]^{x+}[Aⁿ⁻]_{x/n}.yH₂O (I),
wherein
M^{II} denotes a divalent metal ion selected from the group consisting of Ca, Mg, Fe, Ni, Zn, Co, Cu and Mn or 2Li,
M^{III} denotes a trivalent metal ion selected from the group consisting of Al, V, Co, Sc, Ga, Y, Fe, Cr and Mn,
Aⁿ⁻ denotes an n-valent anion selected from the group consisting of OH⁻, CH₃COO⁻, PO₄³⁻, Cl⁻, Br⁻, NO₃⁻, CO₃²⁻, SO₄²⁻ and SeO₄²⁻,
x is the mole fraction having a value ranging from 0.1 to 0.5 and
y is a value ranging from 0 to 5.0,
(B) pumping said solid particles-stabilized emulsion through a conduit or pipeline and
(C) breaking the solid particles-stabilized emulsion by application of a magnetic field to obtain oil.

In a more preferred embodiment, the presently claimed invention relates to a method of transporting oil comprising the steps of
(A) providing a solid particles-stabilized emulsion containing water as continuous phase, oil in the form of droplets having an average droplet size Dv₅₀ in the range of 5 to 60 μm as a dispersed phase and at least one magnetic solid particle which comprises layered double hydroxide of general formula (I)

[M^{II}₍₁₋ₓ₎M^{III}ₓ(OH)₂]^{x+}[Aⁿ⁻]_{x/n}.yH₂O (I),
wherein
M^{II} denotes a divalent metal ion selected from the group consisting of Mg, Fe, Ni, Mn and Co,
M^{III} denotes Fe,
Aⁿ⁻ denotes an n-valent anion selected from the group consisting of Cl⁻, Br⁻, NO₃⁻, CO₃²⁻, SO₄²⁻ and SeO₄²⁻,
x is the mole fraction having a value ranging from 0.1 to 0.5 and
y is a value ranging from 0 to 5.0,
(B) pumping said solid particles-stabilized emulsion through a conduit or pipeline and
(C) breaking the solid particles-stabilized emulsion by application of a magnetic field to obtain oil.

Preferably, the water contains ions. Preferably, the total ion concentration is in the range of 3000 to 300000 mg/l, more preferably the total ion concentration is in the range of 100000 to 250000 mg/l, most preferably the total ion concentration is in the range of 200000 to 220000 mg/l.

Preferably the solid particles-stabilized emulsion has a conductivity in the range of 50 to 190 mS/cm, more preferably in the range of 130 to 160 mS/cm.

Preferably the solid particles-stabilized emulsion is free of surfactants. The surfactant can be an anionic, zwitterionic or amphoteric, nonionic or cationic surfactant, or a mixture of two or more of these surfactants. Examples of suitable anionic surfactants include carboxylates, sulfates, sulfonates, phosphonates, and phosphates. Examples of suitable nonionic surfactants include alcohol ethoxylates, alkyl phenol ethoxylates, fatty acid ethoxylates, sorbitan esters and their ethoxylated derivatives, ethoxylated fats and oils, amine ethoxylates, ethylene oxide-propylene oxide copolymers, surfactants derived from mono- and polysaccharides such as the alkyl polyglucosides, and glycerides. Examples of suitable cationic surfactants include quaternary ammonium compounds. Examples of zwitterionic or amphoteric surfactants include N-alkyl betaines or other surfactants derived from betaines.

In step (B), the magnetic solid particles-stabilized emulsion is transported by pumping said solid particles-stabilized emulsion through a conduit or pipeline

The solid particles-stabilized emulsions are good candidates for transportation in pipelines and/or conduits using flow regimes of either self-lubricating core annular flow or as uniform, lower-viscosity solid particles-stabilized emulsions. In core annular flow, forming a low-viscosity annulus near the pipe wall further reduces pressure drop. Because the viscosity of a solids-stabilized emulsion is not greatly affected by temperature, such solid particles-stabilized emulsions do not have to be heated to high temperature to maintain an acceptably low viscosity for economical transport.

In step (C) the solid particles-stabilized emulsion is broken, preferably completely or partially, more preferably completely, by application of a magnetic field to obtain oil.

Breaking of emulsions by magnetic coalescence is described in U.S. Pat. No. 5,868,939. However, U.S. Pat. No. 5,868,939 discloses that both a magnetic additive such as water-soluble ferromagnetic compounds and a second additive such as surfactants are required to afford breaking of the emulsion.

In general, step (C) can be carried out with any magnetic equipment that is suitable to separate magnetic particles from dispersion, e. g. drum separators, high or low intensity magnetic separators, continuous belt type separators or others.

Step (C) can, in a preferred embodiment, be carried out by applying a permanent magnet to the reactor and/or vessel in which the magnetic solid particles-stabilized emulsion is present. In a preferred embodiment, a dividing wall composed of nonmagnetic material, for example the wall of the separator, reactor and/or vessel, is present between the permanent magnet and the magnetic solid particles-stabilized emulsion. In a preferred embodiment, step (C) is conducted in reactors that are covered at least partially with permanent magnets at the inside. These permanent magnets can be controlled mechanically.

In a preferred embodiment, step (C) is conducted continuously or semi-continuously, wherein preferably the magnetic solid particles-stabilized emulsion to be treated flows through the separator. Flow velocities of the magnetic solid particles-stabilized emulsion to be treated are in general adjusted to obtain an advantageous yield of magnetic agglomerates separated.

The pH-value of the magnetic solid particles-stabilized emulsion which is treated according to step (C) is in general neutral or weakly acidic, preferably being a pH-value of about 5 to 10, more preferably being a pH-value of about 5 to 8.

The magnetic solid particles can be separated from the magnetic surface and/or the unit wherein magnetic separation is conducted by all methods known to those skilled in the art.

In a preferred embodiment the magnetic solid particles are removed by flushing with a suitable dispersion medium. In a preferred embodiment, water is used to flush the separated magnetic solid particles.

The separated magnetic solid particles can be dewatered and/or dried afterwards by processes known to those skilled in the art.

The separated magnetic solid particles can be recycled and used again in a process for the transportation of oil which leads to the overall economy of the inventively claimed process.

In order to separate the oil and water, the solid particles-stabilized emulsion can further be treated with chemicals. These chemicals are referred to as dehydration chemicals or demulsifiers. Demulsifiers allow the dispersed droplets of the emulsion to coalesce into larger drops and settle out of the matrix. For example, U.S. Pat. No. 5,045,212; U.S. Pat. No. 4,686,066; and U.S. Pat. No. 4,160,742 disclose examples of chemical demulsifiers used for breaking emulsions. In addition, commercially available chemical demulsifiers, such as ethoxylated-propoxylated phenolformaldehyde resins and ethoxylated-propoxylated alcohols, are known for demulsification of crude oils. Preferably, the solid particles-stabilized emulsion does not need to be treated with demulsifiers in order to affect breaking up of the emulsion.

The present invention has been described in connection with its preferred embodiments. However, to the extent that the foregoing description was specific to a particular embodiment or a particular use of the invention, this was intended to be illustrative only and is not to be construed as limiting the scope of the invention. On the contrary, it was intended to cover all alternatives, modifications, and equivalents that are included within the spirit and scope of the invention, as defined by the appended claims.

### EXAMPLES

### Methods

XRD

X-ray powder diffraction: The determinations of the crystallinities were performed on a D8 Advance series 2 diffractometer from Bruker AXS. The diffractometer was configured with an opening of the divergence aperture of 0.1° and a Lynxeye detector. The samples were measured in the range from 2° to 70° (2 Theta). After baseline 30 correction, the reflecting surfaces were determined by making use of the evaluation software EVA (from Bruker AXS). The ratios of the reflecting surfaces are given as percentage values.

SEM (Method A)

Powder samples were investigated with the field emission scanning electron microscope (FESEM) Hitachi S-4700, which was typically run at acceleration voltages between 2 kV and 20 kV. Powder samples were prepared on a standard SEM stub and sputter coated with a thin platinum layer, typically 5 nm. The sputter coater was the Polaron SC7640. The sizes of LDH particles, diameter and thickness, were counted manually from SEM images. 50 particles were picked up randomly, and their sizes were measured. The averages were defined by the particle sizes. Aspect ratio was determined as the ratio of diameter/thickness.

Elemental Analysis

Composition of the obtained materials is measured with flame atomic absorption spectrometry (F-AAS) and inductively coupled plasma optical emission spectrometry (ICP-OES).

Magnetization

A cell was charged with the samples in substantially the closest packed state and closed with a cap. The amount of sample in the cell was found to be 20 to 30 mg. Each of the samples was set in a sample holder of a vibrating sample magnetometer (VSM) and measured for hysteresis curve at a magnetic field of ±20 Tesla.

### Example A

### Preparation of Non-Magnetic Particles

Solution A: Mg(NO₃)₂.6H₂O (230.8 g) and Al(NO₃)₃.9H₂O (84.5 g) were dissolved in deionized water (562.5 ml). Solution B: NaOH (72.0 g) and Na₂CO₃.10H₂O (47.8 g) were dissolved in deionized water (562.5 ml) to form the mixed base solution. Solution A (562.5 ml) and solution B (562.5 ml) were simultaneously added dropwise to a vessel containing stirred deionized water (450 ml). The pH of the reaction mixture was around 8.7. The mixing process was carried out at room temperature. The resulting slurry was transferred to an autoclave and aged at 100° C. for 13 h with 150 U/min stirring. The pH of the resulting slurry was 8.5. The precipitate was then centrifuged, washed well with 23 L of deionized water and dried at 60° C. and 120° C. overnight.

The characterization of the final product by XRD shows that the product has the typical layered double hydroxide structure characteristic. The SEM image shows that the product is a disk shaped material with the diameter of 50-200 nm, the thickness of around 10-20 nm and aspect ratio of 2.5-20. The elemental analysis indicates an elemental composition of Mg (23.1 wt.-%) and Al (8.0 wt.-%)

### Example B

### Preparation of Magnetic Particles

Solution A: Mg(NO₃)₂.6H₂O (230.8 g) and Fe(NO₃)₃.9H₂O (84.5 g) were dissolved in deionized water (562.5 ml). Solution B: NaOH (72.0 g) and Na₂CO₃.10H₂O (47.8 g) were dissolved in deionized water (562.5 ml) to form the mixed base solution. Solution A (562.5 ml) and solution B (562.5 ml) were simultaneously added dropwise to a vessel containing stirred deionized water (450 ml). The pH of the reaction mixture was around 9.5. The mixing process was carried out at room temperature. The resulting slurry was transferred to autoclave and aged at 100° C. for 13 h with 150 U/min stirring. The pH of resulting slurry was 9.1. The slurry was washed well with 23 L of deionized water and dried at 120° C. overnight.

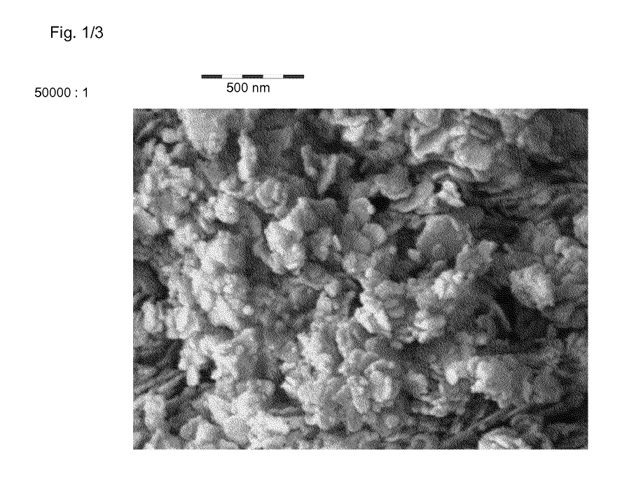

The characterization of the final product by XRD as shown table 1 shows that the product has the typical layered double hydroxide structure characteristic. The SEM image (FIG. 1) shows that the product is a disk shaped material with the diameter of 50-200 nm, the thickness of around 10-20 nm, and aspect ratio of 2.5-20. The elemental analysis indicates an elemental composition of Mg (13.7 wt. %) and Fe (30.0 wt. %).

TABLE 1

| d value | Intensity |
|---|---|
| Angstrom | % |
| 7.71937 | 90.9 |
| 3.84265 | 87.4 |
| 2.63749 | 69.4 |
| 2.35247 | 43.1 |
| 1.98895 | 38.4 |
| 1.55368 | 95.4 |
| 1.52284 | 100 |
| 1.43987 | 39.6 |

### Example C

### Preparation of Magnetic Particles

Solution A: Mg(NO₃)₂.6H₂O (230.8 g) and Fe(NO₃)₃.9H₂O (169.0 g) were dissolved in deionized water (562.5 ml). Solution B: NaOH (72.0 g) and Na₂CO₃.10H₂O (47.8 g) were dissolved in deionized water (562.5 ml) to form the mixed base solution. Solution A (562.5 ml) and solution B (562.5 ml) were simultaneously added dropwise to a vessel containing stirred deionized water (450 ml). The pH of the reaction mixture was around 9.5. The mixing process was carried out at room temperature. The resulting slurry was transferred to autoclave and aged at 100° C. for 13 h with 150 U/min stirring. The pH of resulting slurry was 9.1. The slurry was washed well with 23 L of deionized water and dried at 120° C. overnight.

Determination of Magnetization

Characterization of magnetization for samples B (MgFe-LDH) and C (MgFe-LDH) can be seen in FIG. 2. Sample A (MgAl-LDH) is not magnetic, in contrast sample B is paramagnetic and sample C is a mixture between a para- and ferromagnet. The difference between sample B and C is that sample C contains twice as much Fe than sample B. Sample B has a magnetization of 0.3 Am²/kg (at 1 Tesla) whereas sample C shows a magnetization of 1.3 Am²/kg (at 1 Tesla). The samples were measured at 300 K.

Preparation of the Magnetic Emulsion and Phase Separation

The oils used in the experiments are as follows:

mineral oil (PIONIER 1912, H&R Vertrieb GmbH, 31.4 mPa·s @20° C.)

crude oil-1 (Wintershall Holding GmbH, 226 mPa·s @20° C.)

crude oil-2 (Wintershall Holding GmbH, more than 1000 mPa·s @20° C.)

The emulsification tests were carried out as follows:

1 g of the obtained magnetic samples as described above and 10 ml of oil were added to 90 ml of salt water. The suspension was heated at 60° C. for 1 hour while stirring. After heating, the suspension was stirred with an Ultra-turrax at 15′10³ rpm for 3 minutes. Salt water was obtained by dissolving 56429.0 mg of CaCl₂.2H₂O, 22420.2 mg of MgCl₂.6H₂O, 132000.0 mg of NaCl, 270.0 mg of Na₂SO₄, and 380.0 mg of NaBO₂.4H₂O to 1 L of deionized water and adjusting the pH to 5.5-6.0 with HCl afterwards.

Six pieces of permanent magnets (S-35-30-N, commercially available from Webcraft GmbH, Germany) were attached to a side of a glass bottle with emulsion overnight.

Stability

The stability of the emulsion was determined by comparing the height of emulsion phases just after forming and after a certain time.

A picture of the emulsion was taken with a digital camera right after making the emulsion, and after 1 hour, 24 hours, and 1 week. The height of emulsion gradually decreased due to creaming. The stability of the emulsion is defined as a ratio of the height of the emulsion phase right after making the emulsion and after 24 hours.

Droplet Size

The droplet size of the emulsion droplets was measured by laser diffraction in accordance to ISO13320. The value of Dv₅₀ was used for comparison.

Type

The type of emulsion (oil in water type or water in oil type) was determined by conductivity measurement.

After 24 hours from making an emulsion, the conductivity of the emulsion was measured with a conductivity meter (LF330, Wissenschaftlich-Technische Werkstatten GmbH). When the conductivity of an emulsion is more than 10 μS/cm, it indicates that the emulsion is of the oil in water type. When conductivity of an emulsion is less than 10 μS/cm, it indicates that the emulsion is of the water in oil type (Langmuir 2012, 28, 6769-6775).

Viscosity

Viscosity was measured by a rotational viscosity meter at 20° C. and 60° C. in accordance to DIN 53019.

<Emulsion 1>

The compositions of emulsion 1 are as follows: 1 g of hydrotalcite as prepared according to Example B (Mg²⁺, Fe³⁺, CO₃²⁻), 10 ml of mineral oil (PIONIER 1912, H&R Vertrieb GmbH, 31.4 mPa·s @20° C.), and 90 ml of salt water.

The stability of the emulsion 1 is 33.3% height after 24 hours. The conductivity of this emulsion was 159 mS/cm which indicates that this emulsion is of the oil in water type. The results of laser diffraction indicate that the oil droplets of this emulsion have a Dv₅₀ of 19.4 μm. The viscosity was 4 mPa·s @ 20° C. and 4 mPa·s @ 60° C. (under shear rate of 10/s).

<Emulsion 2>

The compositions of emulsion 2 are as follows: 1 g of hydrotalcite as prepared according to Example B (Mg²⁺, Fe³⁺, CO₃²⁻), 10 ml of crude oil-1 (Wintershall Holding GmbH, 226 mPa·s @20° C.), and 90 ml of salt water.

The stability of the emulsion 1 is 26.1% height after 24 hours. The conductivity of this emulsion was 130 mS/cm which indicates that this emulsion is of the oil in water type. The results of laser diffraction indicate that the oil droplets of this emulsion have a Dv₅₀ of 16.5 μm. The viscosity was 9.1 mPa·s @ 20° C. and 13 mPa·s @ 60° C. (under shear rate of 10/s).

<Emulsion 3>

The compositions of emulsion 3 are as follows: 1 g of hydrotalcite as prepared according to Example B (Mg²⁺, Fe³⁺, CO₃²⁻), 10 ml of crude oil-2 (Wintershall Holding GmbH, more than 1000 mPa·s @20° C.), and 90 ml of salt water.

The stability of the emulsion 1 is 42.9% height after 24 hours. The conductivity of this emulsion was 140 mS/cm which indicates that this emulsion is of the oil in water type. The results of laser diffraction indicate that the oil droplets of this emulsion have a Dv₅₀ of 30.0 μm. The viscosity was 12 mPa·s @ 20° C. and 12 mPa·s @ 60° C. (under shear rate of 10/s).

The data indicate that the viscosity of viscous crude oil can be significantly reduced by the formation of the solid particles-stabilized emulsions within the scope of the presently claimed invention. These emulsions can be facilitatingly pumped through a conduit or pipeline for further processing whereas crude oil per se is difficult, if not impossible, to transport through a pipeline. The inventively claimed solid particles-stabilized emulsions are also sufficiently stable for a transport through a pipeline.

After attaching the permanent magnets to emulsion 1 overnight the oil droplets of emulsion 1 moved to the magnets which indicates that the product is magnetic. The results of laser diffraction suggest that the oil droplets in the emulsion have a Dv₅₀ of 19.4 μm before magnetic attachment and a Dv₅₀ of 19.5 μm after magnetic attachment. There results indicate that there are not any big differences in the oil droplet size between before and after magnetic attachment.

After attaching the permanent magnet to the emulsion overnight a phase separation was observed that shows that the emulsion was broken.

After breaking of the emulsion the magnetic hydrotalcite was recollected.

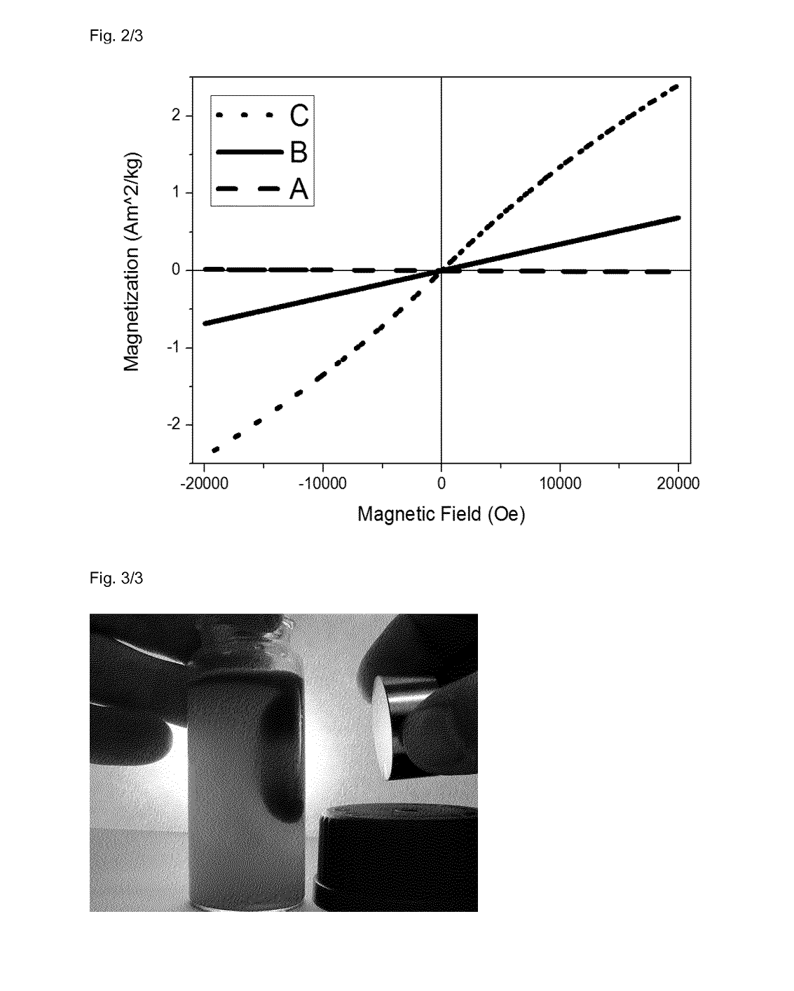

In an additional experiment it was observed that after placing the permanent magnet next to the vial the emulsion droplets moved towards the magnet (FIG. 3/3).

Preparation of the Non-Magnetic Emulsion (Emulsion 4)

1 g of the obtained non-magnetic sample (Example A) as described above and 10 ml of oil were added to 90 ml of salt water. The suspension was heated at 60° C. for 1 hour while stirring. After heating, the suspension was stirred with an Ultra-turrax at 15*10³ rpm for 3 minutes. Salt water was obtained by dissolving 56429.0 mg of CaCl₂.2H₂O, 22420.2 mg of MgCl₂.6H₂O, 132000.0 mg of NaCl, 270.0 mg of Na₂SO₄, and 380.0 mg of NaBO₂.4H₂O to 1 L of deionized water, adjusting pH to 5.5-6.0 with HCl afterwards.

The compositions of emulsion 4 are as follows: 1 g of hydrotalcite as prepared according to Example A (Mg²⁺, Al³⁺, CO₃²⁻), 10 ml of mineral oil (PIONIER 1912, H&R Vertrieb GmbH, 31.4 mPa·s @20° C.), and 90 ml of salt water.

The conductivity of this emulsion was 152 mS/cm which indicated that this emulsion was of the oil in water type. The results of laser diffraction indicated that this emulsion had a Dv₅₀ of 12.9 μm. The viscosity was 4 mPa·s @ 20° C. and 4 mPa·s @ 60° C. (under shear rate of 10/s). After attaching the permanent magnets to emulsion 4 overnight the oil droplets in emulsion 4 did not move to the magnet indicating that the product is non-magnetic, which was additionally proven by VSM measurements (FIG. 2/3)

1.-15. (canceled)

16. A method of transporting oil comprising the steps of
(A) providing a solid particles-stabilized emulsion comprising water as continuous phase, oil as a dispersed phase and at least one magnetic solid particle which comprises layered double hydroxide,
(B) pumping said solid particles-stabilized emulsion through a conduit or pipeline
and
(C) breaking the solid particles-stabilized emulsion by applying a magnetic field to obtain oil.

17. The method according to claim 16, wherein the oil has a viscosity in the range of 1 to 10000 mPa·s at a temperature of 20° C. according to DIN 53019.

18. The method according to claim 16, wherein the solid-particles stabilized emulsion has a viscosity in the range of 1 to 30 mPa·s at a temperature of 20° C. under shear rate of 10/s according to DIN 53019.

19. The method according to claim 16, wherein the solid particles-stabilized emulsion comprises 10 to 99% by weight water, 10 to 90% by weight oil and 0.1 to 10% by weight of the at least one magnetic solid particle.

20. The method according to claim 16, wherein the oil is present in the form of droplets in the dispersed phase, whereby the droplets have an average droplet size Dv₅₀ in the range of 1 to 40 μm determined according to ISO13320.

21. The method according to claim 16, wherein the solid particles have an average particle size in the range of 30 nm to 10 μm determined according to SEM.

22. The method according to claim 16, wherein the solid particles show a magnetization in the range of 0.1 to 80.0 Am²/kg in a magnetic field of 1 Tesla at 300 K.

23. The method according to claim 16, wherein the layered double hydroxide is of formula (I)
[M^{II}₍₁₋ₓ₎M^{III}ₓ(OH)₂]^{x+}[Aⁿ⁻]_{x/n}.yH₂O (I),
wherein
M^{II} is a divalent metal ion or 2Li,
M^{III} is a trivalent metal ion,
Aⁿ⁻ is an n-valent anion,
n is 1 or 2,
x is the mole fraction having a value ranging from 0.1 to 0.5 and
y is from 0 to 5.0.

24. The method according to claim 23, wherein the divalent metal ion is Ca, Mg, Fe, Ni, Zn, Co, Cu or Mn,
the trivalent metal ion is Al, V, Co, Sc, Ga, Y, Fe, Cr or Mn,
the n-valent anion is OH⁻, CH₃COO⁻, PO₄³⁻, Cl⁻, Br⁻, NO₃⁻, CO₃²⁻, SO₄²⁻ or SeO₄²⁻,
x is the mole fraction having a value ranging from 0.1 to 0.5 and
y is from 0 to 5.0.

25. The method according to claim 16, wherein the solid particles-stabilized emulsion has a conductivity in the range of 50 to 190 mS/cm.

26. The method according to claim 16, wherein step (C) is carried out in magnetic equipment selected from the group consisting of drum separators, high or low intensity magnetic separators and continuous belt type separators.

27. The method according to claim 16, wherein the magnetic field is produced by magnetic wires and/or magnetic rods.

28. The method according to claim 16, wherein the magnetic field is produced by a permanent magnet.

29. The method according to claim 16, wherein step (B) and/or step (C) are carried out continuously.

30. A method of transporting oil comprising the steps of
(A) providing a solid particles-stabilized emulsion containing water as continuous phase, oil in the form of droplets having an average droplet size Dv₅₀ in the range of 1 to 100 μm as a dispersed phase and at least one magnetic solid particle which comprises layered double hydroxide of general formula (I)
[M^{II}₍₁₋ₓ₎M^{III}ₓ(OH)₂]^{x+}[Aⁿ⁻]_{x/n}.yH₂O (I),
wherein
M^{II} is a divalent metal ion selected from the group consisting of Ca, Mg, Fe, Ni, Zn, Co, Cu and Mn or 2Li,
M^{III} is a trivalent metal ion selected from the group consisting of Al, V, Co, Sc, Ga, Y, Fe, Cr and Mn,
Aⁿ⁻ is an n-valent anion selected from the group consisting of OH⁻, CH₃COO⁻, PO₄³⁻, Cl⁻, Br⁻, NO₃⁻, CO₃²⁻, SO₄²⁻ and SeO₄²⁻,
x is the mole fraction having a value ranging from 0.1 to 0.5 and
y is from 0 to 5.0,
(B) pumping said solid particles-stabilized emulsion through a conduit or pipeline
and
(C) breaking the solid particles-stabilized emulsion by application of a magnetic field to obtain oil.
